(19) United States
(12) Patent Application Publication
(10) Pub. No.: US 2011/0077074 A1
(43) Pub. Date: Mar. 31, 2011

(54) Sustainable online game-saving the world

(76) Inventor: Frank Dehnhard, Lubeck (DE)

(21) Appl. No.: 12/387,231

(22) Filed: Apr. 30, 2009

(51) Int. Cl. A63F 9/24; G09B 19/00

(52) U.S. Cl. 463/26; 434/217

(57) ABSTRACT

The “sustainable online game” specified by
using the internet for a worldwide online education in terms of environment, climate change, health and education
using a money jackpot to increase the personal benefit for users to take part in which the money for the jackpot is generated from online advertisements
using activities like personal CO2 reduction and CO2 trading to increase the probability to win the jackpot

### CROSS REFERENCE

provisional application 61/064,207

### BACKGROUND OF THE INVENTION

The threatening climate change, increasing poverty, increasing numbers of refugees need fast and worldwide action.

The only way to reach hundreds of millions in a short time with a lot of fast changing information is the internet. To make it more attractive that these people really take part and take action is an online game in form of a lottery. A high Start-Jackpot leads to a high attraction to take part every day. Users can increase the probability to win by taking action, by informing friends, by saving CO2 and by investing money (like a lottery). Furthermore they-save money by saving energy (everyday recommendations and tips). Interesting short films, games and other attractions will lead to a high number of users. Advertisements regarding “green” products as well as questionnaires regarding the personal environmental behaviour lead to an increasing jackpot and later to an installation of a worldwide CO2 trading system. First as a part of the game, later as an official system to mitigate greenhouse gases. The money will automatically be transferred to poor people and poor countries. The system can be used as well for health education as for environment or social aspects (raising children . . . ).

Past:

Up to now many different sources give information about the vital problems but only few listen to those. The people have no personal benefit. By installing a high Jackpot the benefit is obvious.

1. The “sustainable online game” specified by
using the internet for a worldwide online education in terms of environment, climate change, health and education
using a money jackpot to increase the personal benefit for users to take part in which the money for the jackpot is generated from online advertisements
using activities like personal CO2 reduction and CO2 trading to increase the probability to win the jackpot
